(19) United States
(12) Patent Application Publication
(10) Pub. No.: US 2024/0385816 A1
(43) Pub. Date: Nov. 21, 2024

(54) METHOD, APPARATUS, DEVICE AND MEDIUM FOR CODE REVIEW

(71) Applicant: Beijing Zitiao Network Technology Co., Ltd., Beijing (CN)

(72) Inventor: Junyu Yue, Beijing (CN)

(21) Appl. No.: 18/665,347

(22) Filed: May 15, 2024

(30) Foreign Application Priority Data
May 16, 2023 (CN) 202310546601.1

(51) Int. Cl. G06F 8/41

(52) U.S. Cl. CPC G06F 8/427

(57) ABSTRACT

Embodiments of the present disclosure provide a method, apparatus, device and medium for code review. A specific embodiment of the process comprises: in response to a merge request to target code, determining a call to a target element in the target code; and sending a code review request to a reviewer associated with the target element according to the call to the target element. By this method, a code review request can be sent for a particular code element so that, for example, a development user or a maintenance user of the particular code element can perform a code review on the manner of the call to the particular code element.

### CROSS-REFERENCE TO RELATED APPLICATION(S)

This application claims priority to Chinese Application No. 202310546601.1 filed in May 16, 2023, the disclosure of which is incorporated herein by reference in its entity.

### FIELD

Embodiments of the present disclosure generally relate to a technical field of code analysis and code review, and more specifically, to a method, apparatus, device and medium for code review.

### BACKGROUND

Existing code review scheme typically specify that a reviewer reviews code in a code file or a code catalogue, after a user submits the code, in order to find out possible code writing problems before the code is merged into a code repository. However, in some software production scenarios, for example, for development user of a particular code element, the above code review schemes for code file and code catalogue levels make it difficult for the development user to perform code review on the call to the particular code element.

Therefore, there is a need for a new method for code review.

### SUMMARY

Embodiments of the present disclosure provide a method, apparatus, device and medium for code review.

In a first aspect of the present disclosure, there is provided a method for code review, comprising:
in response to a merge request to target code, determining a call to a target element in the target code; and
sending a code review request to a reviewer associated with the target element, according to the call to the target element.

In a second aspect of the present disclosure, there is provided an apparatus for code review, comprising:
a response unit configured to, in response to a merge request to target code, determine a call to a target element in the target code; and
a review unit configured to send a code review request to the reviewer associated with the target element according to the call to the target element.

In a third aspect of the present disclosure, there is provided a computer-readable storage medium stored thereon a computer program which, when executed in a computer, causes the computer to perform the method of the first aspect.

In a fourth aspect of the present disclosure, there is provided an electronic device comprising a memory and a processor, wherein the memory is stored therein executable code stored therein, and the processor is configured to, when executing the executable code, implement the method of the first aspect.

Embodiments of the present disclosure provide a method, apparatus, device and medium for code review. In response to a merge request to target code, a call to the target element in the target code is determined. Then, a code review request is sent to a reviewer associated with the target element according to the call to the target element. By any one of the above method, apparatus, storage medium and electronic device, a code review request can be sent for a particular code element so that, for example, a development user or a maintenance user of the particular code element can perform a code review on the manner of the call to the particular code element.

### BRIEF DESCRIPTION OF THE DRAWINGS

FIG. 1 illustrates a schematic diagram of a code review scheme;

FIG. 2 illustrates a schematic diagram of a method for code review according to an embodiment of the present disclosure;

FIG. 3 illustrates a schematic flow diagram of a method for code review according to an embodiment of the present disclosure;

FIG. 4 illustrates a schematic diagram of converting code into an abstract syntax tree according to an embodiment of the present disclosure;

FIG. 5 illustrates a schematic diagram for determining whether to merge code according to an embodiment of the present disclosure;

FIG. 6 illustrates a schematic block diagram of an apparatus for code review according to another embodiment of the present disclosure;

FIG. 7 illustrates a schematic structure diagram suitable for implementing an electronic device of an embodiment of the present disclosure; and

FIG. 8 illustrates a schematic structure diagram suitable for implementing a storage medium of an embodiment of the present disclosure.

### DETAILED DESCRIPTION OF EMBODIMENTS

The technical solutions provided in the present specification are described in further detail below with reference to the accompanying drawings and examples. It should be understood that the particular embodiments described herein are merely illustrative of the relevant invention and are not limiting of the invention. It is further noted that, for ease of description, only parts that are relevant to the invention are shown in the drawings. It should be noted that embodiments and features of embodiments of the present disclosure may be combined with each other without conflict.

In describing embodiments of the present disclosure, the term “include” and its variants are to be understood as open-ended terms that mean “include, but not limited to”. The term “based on” is to be understood as “based at least in part on”. The terms “one embodiment” or “the embodiment” is to be understood as “at least one embodiment”. The term “some embodiments” is to be understood as “at least some embodiments”. The following text may also include other explicit and implicit definitions.

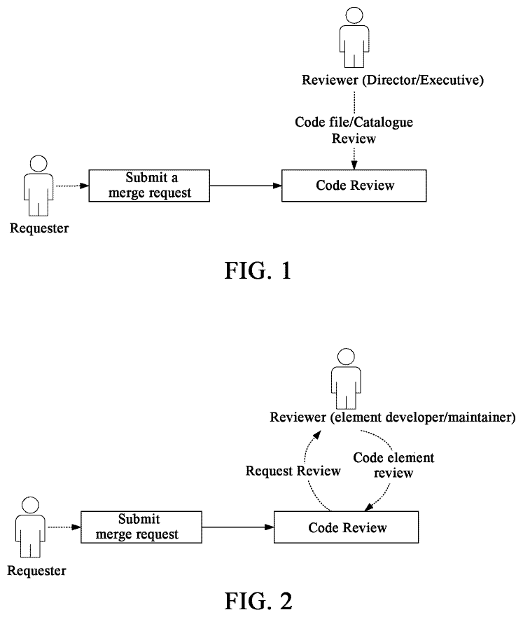

Code Review is to find out the writing problem in the code by specifying the reviewer to check whether the submitted code meets a coding standard. Existing code review schemes typically specify the reviewer to review the code in the code file or the code catalogue, after a requesting user submits a merge request for the code, in order to find out possible code writing problems before the code is merged into a target code branch (e.g., a backbone branch). The merge request, also referred to as a branch Merge Request (MR), or a Pull Request, means that a development user can merge a developed code onto a code branch desired to be saved by means of a request for merging. Further, the reviewer can perform code review on the code that the development user requested to merge. FIG. 1 illustrates a schematic diagram of a code review scheme. As shown in FIG. 1, for example, a code development user (a requesting user) who wishes to merge code developed by the user into the target code branch, may submit a code merge request, and designate a reviewer (e.g., a directing user, a supervising user, or other member of a team to which the requesting user belongs) to review the code submitted by the user. After a code reviewer reviews the submitted code or code changes (code file/code catalogue), depending on the result of the review, the code may be merged into or rejected to be merged into the code repository, for example.

However, in some software production scenarios, such as for development users of particular code elements, the above code review schemes for code file and code catalogue levels often fail to meet the code review needs of these development users for the particular code elements. In particular, when, for example, the development users do not want the particular code elements to be called in an unscheduled manner, it is desirable to review the manner of the call to the particular code elements in the code. However, since these development users are only responsible for the development of the particular code elements, and not responsible for the code file or code catalogue corresponding to the submitted, the existing code review schemes for code file and code catalogue levels typically do not assign a review request corresponding to the code file or the code catalogue to these development users. Thus, existing code review schemes for code file and code catalogue levels make it difficult for these development users to perform code review, for example, on the manner of the call to the particular code element.

In order to solve the above technical problem, embodiments of the present disclosure provide a method for code review. In some embodiments, upon receiving a merge request to a target code, a call to a target element in the target code may be determined; and a code review request is then sent to a reviewer associated with the target element based on the call to the target element. FIG. 2 illustrates a schematic diagram of a method for code review according to an embodiment of the present disclosure. As shown in FIG. 2, upon receiving the code merge request submitted by a code development user (a requesting user), for example, the call to the target element may be determined from the target code submitted by the requesting user and a reviewer associated with the target element may be requested to review. Upon review of the call to the target element by the associated user of the target element, the code may be merged into, for example, the target code branch (e.g., the main branch) or rejected to be merged into the target code branch, based on a review result. The advantages of this method are: a call to a particular code element (the target element) from the target code can be determined. Then, according to the call to the target element, the reviewer (e.g., a development user or a maintenance user) associated with the particular code element is requested to review. Thus, it is possible for e.g., the development user or the maintenance user of the particular code element to perform the code review on the manner of the call to the particular code element.

The detailed procedure of the method is described further below.

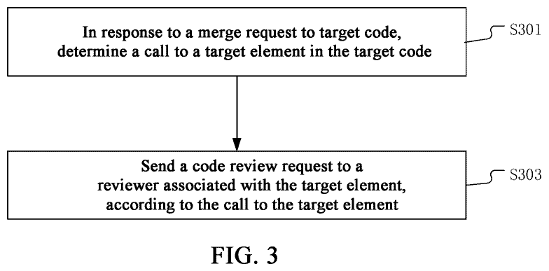

FIG. 3 illustrates a schematic flow diagram of a method for code review according to an embodiment of the present disclosure. As shown in FIG. 3, the method comprises at least the following steps.

In step S301, in response to a merge request to a target code, a call to the target element in the target code is determined.

In step S303, a code review request is sent to a reviewer associated with the target element according to the call to the target element.

First, in step S301, in response to the merge request to the target code, the call to the target element in the target code is determined. In this step, the call to the target element from the target code may be determined after the merge request for the target code is received. In different embodiments, the target code may be program code for different Software products or applications, or program code for different specific purposes. In one example, it is program source code. In various embodiments, the target code may also be program code written in various programming languages, and is not limited in this description.

The target element may be a code element in the target code. In different embodiments, the target element may be a different particular code element. In one embodiment, the target element comprises one or more of a class, a function, an attribute, an operator, an expression, a statement, a clause, a reference package. To facilitate determining the call to the target element in the target code, in one embodiment, the call to the target element in the target code may be determined based on an abstract syntax tree by converting the target code into the abstract syntax tree.

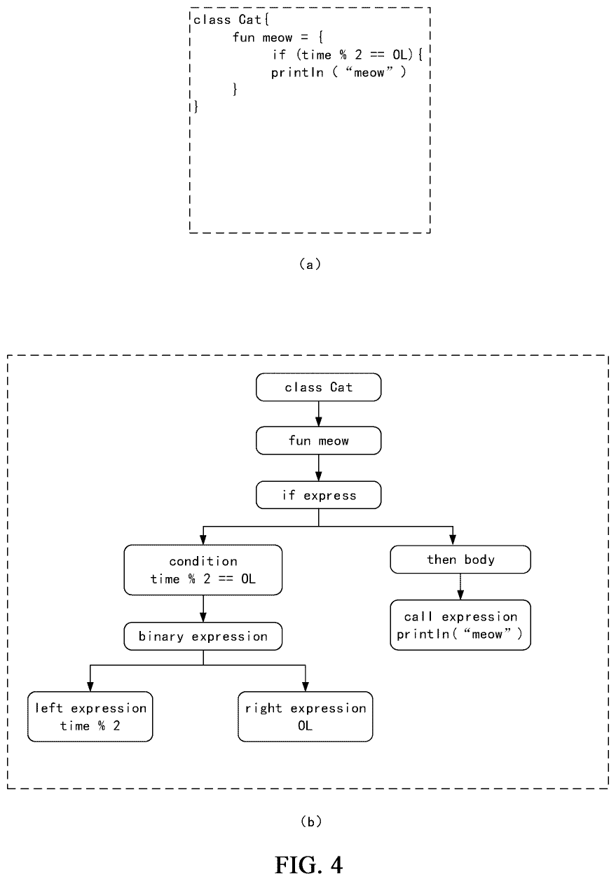

An Abstract Syntax Tree (AST), or simply a Syntax tree, is an abstract representation of the syntax structure of the source code. It represents the syntactic structure of a programming language in the form of a tree, with each node on the tree representing a structural element in the source code, such as a function, variable, expression, etc. Thus, in one particular embodiment, the call to the target element in target code may be determined according to a node corresponding to the target element in the abstract syntax tree. Further, as described above, an encoding language of the target code may be different in different embodiments. Thus, in various embodiments, the converted abstract syntax tree may be an abstract syntax tree corresponding to a different coding language, and this is not limited in this description. FIG. 4 illustrates a schematic diagram of converting a code into an abstract syntax tree according to an embodiment of the present disclosure. Specifically, in the target code shown in FIG. 4 (a), for example, the following code elements are included: class Cat class, fun meow ( ) function, if statement/expression, condition expression and its left and right partial expressions, then clause, println ( ) function, etc. The code as shown in FIG. 4 (a) may be converted into an abstract syntax tree as shown in FIG. 4 (b). Each code element can be respectively represented by a corresponding node, and an edge between respective nodes represents a nesting relationship therebetween, and respective nodes and the edges among them constitute the whole abstract syntax tree. The abstract syntax tree is a structured abstract representation of the target code by which it can be readily determined whether there is a call to a target element in the target code. For example, in one example, if the target element is the println ( ) function, it may be convenient to determine whether there is a call to this target element in the target code according to whether a node corresponding to the println ( ) function exists in the abstract syntax tree by traversing the abstract syntax tree. The specific algorithm for traversing the abstract syntax tree to determine the node corresponding to the target element may vary in different particular embodiments and this is not limited in this description.

As previously mentioned, the target element may be different particular code element in different embodiments. In one embodiment, the target element may also have a preset annotation. The annotation is a special mark in the code. Additional information can be embedded in the source code by annotation without changing the original code and logic. As previously mentioned, in different embodiments, the target code may be based on different programming languages. Thus, in different embodiments, the preset annotation may be user-defined annotation according to language specification of different specific programming language, for instructing code review of the target element. For example, in one embodiment, a code element (e.g., a fun sample) may be attached a preset annotation (e.g., “@) ShouldReview”) in advance, to indicate that the code element is a target element. In this manner, the target element can be quickly determined, for example, according to a code node in the abstract syntax tree that includes a preset annotation sub node.

Then, in step S303, a code review request is sent to the reviewer associated with the target element according to the call to the target element. In this step, the code review request may be sent to the reviewer associated with the target element according to the call to the target element determined in step S301. In different embodiments, the reviewer associated with the target element may be different. In one embodiment, the reviewer associated with the target element may include: a development user of the target element or a maintenance user of the target element. In the embodiment described above where the preset annotation is added to the code element, an identity or a contact address (e.g., “xxx@xcompany. com”) of the associated user of the target element may also be added to a parameter of a preset identity (e.g., “@ ShouldReview (“xxx@xcompany. com”)”). In the above manner, it is convenient to associate the target element with, for example, the development user or the maintenance user in advance. Thereafter, the reviewer associated with the target element may review the manner of the call to the target element in the target code. In a particular embodiment, a code review result of the reviewer on the manner of the call to the target element may include review passed or review failed. The review passed may, for example, indicate that the call to the target element conforms to a predetermined call manner. The review failed may, for example, indicate that the call to the target element does not conform to the predetermined call manner.

As described above, the target element may be a different particular code element in different embodiments. In different embodiments, the predetermined call manner corresponding to the target element may also be different. For example, in the embodiment shown in FIG. 4, a predetermined call manner corresponding to the println ( ) may be, for example, calling a println ( ) function according to a predetermined output format.

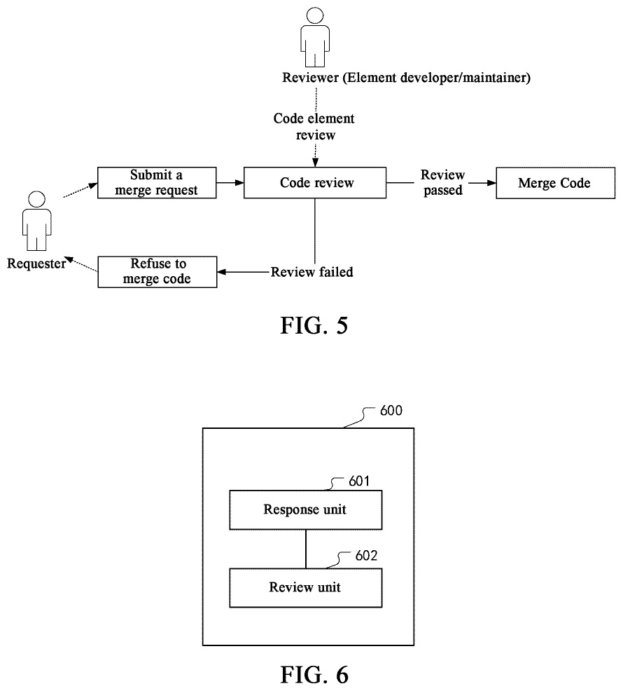

In one embodiment, after the code review result of the reviewer is received, it may be determined whether to merge the target code into a target code branch according to the code review result. A code branch is a copy of software code, by means of which the different development users' “ongoing working code” can be separated from e.g., the tested stable code, thus helping the different development users of the software development team to work in parallel. In general, the code branch may be managed through a Version Control System (VCS), such as a creation, merging or deletion of code branch. In different embodiments, different version control systems may be employed, and are not limited in this description. In one embodiment, in a case that the code review result is review passed, the target code may be merged into the target code branch; and in a case that the code review result is review failed, the target code may be refused to be merged into the target code branch. In different particular embodiments, the target code branch may be a different particular code branch. In one particular embodiment, the target code branch may be a main code branch (alternatively referred to as a backbone branch, or baseline) in a version control system. FIG. 5 illustrates a schematic diagram for determining whether to merge code according to an embodiment of the present disclosure. As shown in FIG. 5, after the reviewer (e.g., the development user or the maintenance user) associated with the code element reviews, for example, the manner of the call to the code element, and in a case that the review result is review passed, the target code may be merged into e.g., the main code branch. For example, in a case that the code review result is review failed, the target code may be refused to be merged into e.g., the main code branch. In this manner described above, it can be enabled that the call manner to the target element in the code merged into the target code branch conforms to the predetermined manner of the development user or the maintenance user of the target element.

In various embodiments, there may be a plurality of target elements in the target code. Thus, calls to the plurality of target elements in the target code may be determined in step S301. In step S303, code review requests are sent to a plurality of reviewers associated with the plurality of target elements. Thereafter, after a plurality of code review results of the reviewers are received, it is determined whether to merge the target code into a target code branch according to the plurality of code review results. In one particular embodiment, in a case that the plurality of code review results each is review passed, the target code is to be merged into the target code branch. In a case that at least one of the plurality of code review results is review failed, the target code is refused to be merged into the target code branch. In this manner, it can be enable that the development users or the maintenance users of the different target elements in the target code may perform the code reviews on the manner of calls to the different target elements. Further, it can be enabled that the call manners to the different target elements in the code merged into the target code branch conform to the predetermined manners of the development users or the maintenance users of the different target elements.

Embodiments of the present disclosure also provide a code generating apparatus. FIG. 6 illustrates a schematic block diagram of a code generating apparatus according to another embodiment of the present disclosure. The apparatus is configured to perform the method shown in FIG. 3. As shown in FIG. 6, an apparatus 600 comprises:
a response unit 601 configured to, in response to a merge request to target code, determine a call to a target element in the target code; and
a review unit 602 configured to send a code review request to a reviewer associated with the target element according to the call to a target element.

Embodiments of the present disclosure also provide an electronic device comprising a memory and a processor, wherein the memory is stored therein executable code, the processor is configured to, when executing the executable code, implement the methods as shown in FIGS. 3 and 4.

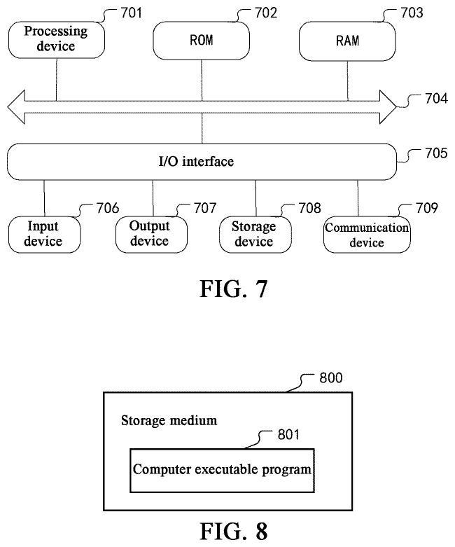

Reference is also made to FIG. 7, which shows a schematic structure diagram suitable for implementing an electronic device 700 of an embodiment of the present disclosure. It is to be understood that the electronic device 700 in FIG. 7 is illustrated only for the purpose of illustration, without suggesting any limitation to function and scope of the present disclosure.

As shown in FIG. 7, the electronic device 700 may include a processing device (e.g., a central processor, a graphics processor, etc.) 701. The processing device 701 may be a general purpose processor, a Digital Signal Processing (DSP), a microprocessor or microcontroller, and may further include an Application Specific Integrated Circuit (ASIC), a Field-Programmable Gate Array (FPGA) or other programmable logic device, discrete gate or transistor logic, discrete hardware components that may perform various suitable actions and processes based on a program stored in a read only memory (ROM) 702 or a program loaded from a storage device 708 into a random access memory (RAM) 703. In the RAM 703, various programs and data required for the operation of the electronic device 700 are also stored. The processing device 701, the ROM 702, and the RAM 703 are connected to each other via a bus 704. An input/output (I/O) interface 705 is also coupled to bus 704.

In general, the following devices may be connected to the I/O interface 705: an input device 706 including, for example, a touch screen, a touch pad, a keyboard, a mouse, etc.; an output device 707 including, for example, a Liquid Crystal Display (LCD), a speaker, a vibrator, etc.; a storage device 708 including, for example, a magnetic tape, a hard disk, etc.; and a communication device 709. The communication device 709 may allow the electronic device 700 to communicate wirelessly or wired with other devices to exchange data. While FIG. 7 illustrates an electronic device 700 having various devices, it is to be understood that not all illustrated devices are required to be implemented or provided. More or fewer devices may alternatively be implemented or provided. Each block shown in FIG. 7 may represent one device or multiple devices as desired.

In particular, the processes described above with reference to flow diagrams may be implemented as a computer software program according to embodiments of the present application. For example, embodiments of the present application include a computer program product comprising a computer program carried on a computer-readable medium, and the computer program comprises program code for performing the method illustrated by the flow diagram. In such embodiments, the computer program may be downloaded and installed from a network via communication device 709, or from storage device 708, or from ROM 702. When the computer program is executed by the processing device 701, the above-described functions defined in the method for code review provided by the embodiment of the present application are performed.

Embodiments of the present disclosure also provide a computer-readable storage medium stored thereon a computer program which, when executed in a computer, causes the computer to perform the method for code review as shown in FIG. 1 provided by embodiments of the present application. FIG. 8 is a schematic diagram implementing a storage medium of an embodiment of the present application. For example, as shown in FIG. 8, the storage medium 800 may be a non-transitory computer-readable storage medium for storing an non-transitory computer-executable instruction 801. The method for code review provided by embodiments of the present application may be implemented when the non-transitory computer-executable instruction 801 is executed by a processor. For example, one or more steps of the method for code review provided according to embodiments of the present application may be performed when the non-transitory computer-executable instruction 801 is executed by the processor. For example, the storage medium 800 may be applied in the electronic device as described above, e.g., the storage medium 800 may comprise a memory in the electronic device. The description of the storage medium 800 may refer to the description of the memory in an embodiment of the electronic device and will not be repeated. Specific functions and technical effects of the storage medium 800 can be referred to the description of the method for code review provided in the embodiment of the present application, and will not be described in detail herein.

Note that the computer-readable medium according to the embodiments of the present disclosure can be either a computer-readable signal medium or a computer-readable storage medium or any combination thereof. The computer-readable storage medium can be, for example but not limited to, an electronic, magnetic, optical, electromagnetic, infrared, or semiconductor system, apparatus, or device, or a combination of any of the above. More specific examples of the computer-readable storage medium may include, but not limited to: an electrical connection having one or more wires, a memory card for a smart phone, a memory component for a tablet computer, a portable computer diskette, a hard disk for a personal computer, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination of the above. In embodiments of the disclosure, a computer-readable storage medium may be any tangible medium that contains or stores a program that can be used by or in connection with an instruction execution system, apparatus, or device. In embodiments of the present disclosure, a computer-readable signal medium may comprise a data signal embodied in baseband or propagated as part of a carrier wave carrying computer-readable program code. Such propagated data signals may take many forms, including but not limited to, electromagnetic signals, optical signals, or any suitable combination of the preceding.

The computer-readable signal medium can also be any computer-readable medium other than a computer-readable storage medium that can send, propagate, or transport the program for use by or in connection with the instruction execution system, apparatus, or device. The program code carried on the computer-readable medium may be transmitted over any suitable medium including, but not limited to: an electric wire, an optical cable, RF (Radio Frequency), etc. or any suitable combination of the above.

The computer readable medium may be contained in the above electronic device; it may also be present separately and not fitted into the electronic device. The computer-readable medium carries one or more programs which, when executed by the server, cause the electronic device to implement the method for code review provided by embodiments of the present application.

Computer program code for carrying out operations of embodiments of the present disclosure may be written in one or more programming languages, including object-oriented programming languages such as Java, smalltalk, C++ and conventional procedural programming languages, such as the “C” language or similar programming languages, or combinations thereof. The program code may be executed entirely on the user's computer, partly on the user's computer, as a stand-alone software package, partly on the user's computer and partly on a remote computer, or entirely on the remote computer or server. In the case of a remote computer, the remote computer may be connected to the user's computer through any kind of network, including a local area network (LAN) or a wide area network (WAN), or it may be connected to an external computer (e.g., through the Internet by an Internet Service Provider).

The flow diagrams and block diagrams in the Figures illustrate the architecture, functionality, and operation of possible implementations of systems, methods and computer program products according to various embodiments of the present disclosure. In this regard, each block in the flow diagrams or block diagrams may represent a module, segment, or portion of code, which comprises one or more executable instructions for implementing the specified logical function(s). It should also be noted that in some alternative implementations, the functions noted in the blocks may occur out of the order noted in the figures. For example, two blocks shown in succession may in fact be executed substantially concurrently or the blocks may sometimes be executed in the reverse order, depending upon the functionality involved. It will also be noted that each block of the block diagrams and/or flow diagrams, and combinations of blocks in the block diagrams and/or flow diagrams, can be implemented by special purpose hardware-based systems which perform the specified functions or operations, or combinations of special purpose hardware and computer instructions. The units described in connection with the embodiments disclosed herein may be implemented in software or hardware. The name of an unit does not in any manner limit the unit itself. The functions described herein above may be performed, at least in part, by one or more hardware logic components. For example, without limitation, exemplary types of hardware logic components that may be used include: field Programmable Gate Arrays (FPGAs), application Specific Integrated Circuits (ASICs), application Specific Standard Products (ASSPs), systems on a Chip (SOCs), complex Programmable Logic Devices (CPLDs), and the like.

The various embodiments described herein are described in a progressive manner with reference to the same or similar parts throughout the various embodiments, each of which focuses on differences from the other embodiments. In particular, the storage medium and computing device embodiments are described more simply because they are substantially similar to the method embodiments, with respect to which reference is made to a partial description of the method embodiments.

The foregoing description is only the preferred embodiments of the disclosure and is illustrative of the principles of the technology employed. It will be appreciated by those skilled in the art that the scope of the present disclosure is not limited to any particular combination of the features described above, but is intended to encompass any combination of the features described above or their equivalents without departing from the spirit of the disclosure. For example, the above-mentioned features and the technical features disclosed in the present disclosure (but not limited to) having similar functions are interchanged to form a technical solution. Further, while operations are depicted in a particular order, this should not be understood as requiring that the operations be performed in the particular order shown or in sequential order. In certain circumstances, multitasking and parallel processing may be advantageous. As such, while several specific implementation details have been included in the above discussion, these should not be construed as limiting the scope of the present disclosure. Certain features that are described in the context of separate embodiments may also be implemented in combination in a single embodiment. Conversely, various features that are described in the context of a single embodiment can also be implemented in multiple embodiments separately or in any suitable subcombination.

The foregoing detailed description further describes objects, aspects and advantages of embodiments of the present invention. Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims. It should be understood that the foregoing description is only illustrative of the embodiments of the present invention, and is not intended to limit the scope of the present invention. Any modifications, equivalent substitutions, improvements, etc. made on the basis of the technical solutions of the present invention shall be included in the protection scope of the present invention.

I/We claim:

1. A method for code review, comprising:
in response to a merge request to target code, determining a call to a target element in the target code; and
sending a code review request to a reviewer associated with the target element, according to the call to the target element.

2. The method of claim 1, wherein the target element comprises one or more of a class, a function, an attribute, an operator, an expression, a statement, a clause, and a reference package.

3. The method of claim 1, wherein determining the call to the target element in the target code comprises:
determining the call to the target element in the target code based on an abstract syntax tree by converting the target code into the abstract syntax tree.

4. The method of claim 3, wherein determining the call to the target element in the target code based on the abstract syntax tree comprises:
determining the call to the target element in the target code according to a node corresponding to the target element in the abstract syntax tree.

5. The method of claim 1, wherein the reviewer associated with the target element comprises: a development user of the target element or a maintenance user of the target element.

6. The method of claim 1, wherein the target element has a corresponding preset annotation.

7. The method of claim 1, further comprising:
receiving a code review result of the reviewer, and determining whether to merge the target code into a target code branch according to the code review result.

8. The method of claim 7, wherein the code review result comprises review passed or review failed; and
determining whether to merge the target code into the target code branch according to the code review result of the reviewer comprises:
in a case that the code review result is review passed, merging the target code into the target code branch; and
in a case that the code review result is review failed, refusing to merge the target code into the target code branch.

9. The method of claim 7, wherein determining the call to the target element in the target code comprises: determining a call to a plurality of target elements in the target code;
sending the code review request to the reviewer associated with the target element comprises: sending the code review request to a plurality of reviewers associated with the plurality of target elements; and
receiving the code review result of the reviewer, and determining whether to merge the target code into the target code branch, comprises:
receiving a plurality of code review results of the reviewers, and determining whether to merge the target code into the target code branch according to the plurality of code review results.

10. The method of claim 9, wherein determining whether to merge the target code into the target code branch according to the plurality of code review results comprises:
in a case that the plurality of code review results each is review passed, merging the target code into the target code branch; and
in a case that at least one of the plurality of code review results is review failed, refusing to merge the target code into the target code branch.

11. A non-transitory computer-readable storage medium stored thereon a computer program which, when executed in a computer, causes the computer to:
in response to a merge request to target code, determine a call to a target element in the target code; and
send a code review request to a reviewer associated with the target element, according to the call to the target element.

12. An electronic device comprising a memory and a processor, wherein the memory is stored therein executable code, and the processor is configured to, when executing the executable code,
in response to a merge request to target code, determine a call to a target element in the target code; and
send a code review request to a reviewer associated with the target element, according to the call to the target element.

13. The electronic device of claim 12, wherein the target element comprises one or more of a class, a function, an attribute, an operator, an expression, a statement, a clause, and a reference package.

14. The electronic device of claim 12, wherein the processor is configured to determine the call to the target element in the target code based on an abstract syntax tree by converting the target code into the abstract syntax tree.

15. The electronic device of claim 14, wherein the processor is configured to determine the call to the target element in the target code according to a node corresponding to the target element in the abstract syntax tree.

16. The electronic device of claim 12, wherein the reviewer associated with the target element comprises: a development user of the target element or a maintenance user of the target element.

17. The electronic device of claim 12, wherein the target element has a corresponding preset annotation.

18. The electronic device of claim 12, wherein the processor is further configured to:
receive a code review result of the reviewer, and determine whether to merge the target code into a target code branch according to the code review result.

19. The electronic device of claim 18, wherein the code review result comprises review passed or review failed; and
the processor is further configured to:
in a case that the code review result is review passed, merge the target code into the target code branch; and
in a case that the code review result is review failed, refuse to merge the target code into the target code branch.

20. The electronic device of claim 18, wherein the processor is configured to:
determine a call to a plurality of target elements in the target code;
send the code review request to a plurality of reviewers associated with the plurality of target elements; and
receive a plurality of code review results of the reviewers, and determine whether to merge the target code into the target code branch according to the plurality of code review results.
